(19) United States
(12) Patent Application Publication
(10) Pub. No.: US 2013/0139455 A1
(43) Pub. Date: Jun. 6, 2013

(54) FIELD REPLACEABLE MOISTURE CONTROL IN NON-SEALED WINDOWS

(71) Applicant: Mueller Door Company, Inc., Wauconda, IL (US)

(72) Inventor: Peter Miller, Wauconda, IL (US)

(73) Assignee: Mueller Door Company, Inc., Wauconda, IL (US)

(21) Appl. No.: 13/682,087

(22) Filed: Nov. 20, 2012

Related U.S. Application Data
(60) Provisional application No. 61/562,712, filed on Nov. 22, 2011.

(51) Int. Cl. E06B 7/12; E06B 3/66

(52) U.S. Cl. CPC E06B 7/12; E06B 3/66
USPC 52/204.593; 52/741.4

(57) ABSTRACT

A window having at least two panes that define a cavity for desiccant, where the desiccant removes water vapor from between the two panes of a window when the panes are not vacuum sealed.

### RELATED APPLICATION

This application claims the priority benefit of U.S. Provisional Patent Application Ser. No. 61/562,712 filed Nov. 22, 2011, titled “FIELD REPLACEABLE MOISTURE CONTROL IN NON-SEALED WINDOWS,” which application is hereby incorporated in its entirety by reference.

### BACKGROUND OF THE INVENTION

1. Field of the Invention

This invention relates generally to windows and more particularly to non-vacuum sealed windows.

2. Related Art

Often in freezer doors, windows are used to aid in determining if it is safe to open the doors and check on the contents without opening the doors and letting warm air into a freezer or cooler. The windows that are found in freezer doors typically have at least two panes of glass with air space between the two panes. The windows in freezer doors are not vacuum sealed and/or gas filled as typically found in highly insulated home windows. This is because such sealed windows cannot withstand the movement and vibrations caused by the opening and closing of the freezer door. The seals prematurely give out causing the window to lose its gas and/or vacuum. A problem exists with windows that have air between the panes when the panes separate cold and warm air as a freezer window does. Namely, condensation appears in the window when moist air makes its way between the panes of glass.

The approaches used in traditional windows of using inert gas or creating a vacuum cannot be used to solve the problem. Current approaches have involved simply replacing the windows every time moisture builds up within the window.

Therefore, there is a need for methods and systems for creating and maintaining non-vacuum sealed windows that enables an increase in serviceability of the window while reducing moisture within the window.

### SUMMARY

Systems and methods consistent with the present invention provide an approach for fabricating and maintain a non-vacuum sealed window with reduced moisture between the panes of glass. A window with at least two panes of glass constructed with a location for holding silica. The silica captures any moisture that may be present between the two panes of glass.

Periodically the silica may be replaced in the field enabling the window to continue to be used, rather than replaced.

Other methods, features and advantages of the invention will be or will become apparent to one with skill in the art upon examination of the following figures and detailed description. It is intended that all such additional methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 illustrates a freezer door with a traditional non-vacuum window as known in the prior art.

FIG. 2 illustrates a freezer door with a window having a predetermined place for silica located within the window in accordance with an example implementation of the invention.

FIG. 3 illustrates a magnified view of the window depicted in FIG. 2 in accordance with an example implementation of the invention.

FIG. 4 illustrates a seal having a predetermined place for silica within the window in accordance with an example implementation of the invention.

FIG. 5 illustrates a magnified view of seal with a cavity for silica within the window of FIG. 4 in accordance with an example implementation of the invention.

FIG. 6 depicts a flow diagram of an approach for placing silica in the air space defined by the panes of a window is depicted in accordance with an example implementation of the invention

### DETAILED DESCRIPTION

Unlike the known approaches previously discussed, a non-vacuum window, such as freezer and cooler windows are able to have moisture removed by silica placed between the panes of the window. Even though freezer windows are used as an example in this application, any non-vacuum sealed windows, such as cooler windows may benefit from the approach described herein.

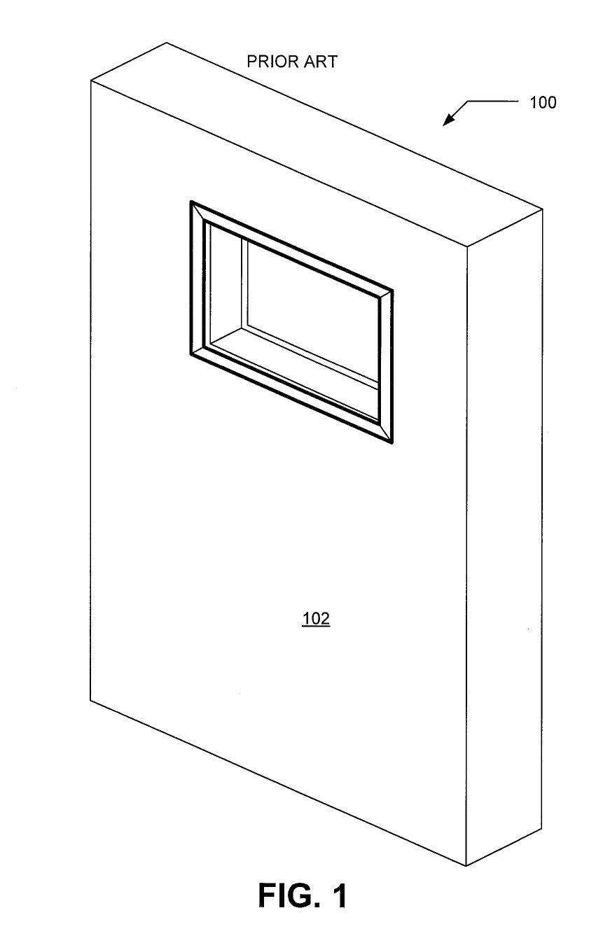

Turning first to FIG. 1, an illustration 100 of a freezer door 102 with a traditional non-vacuum window (NVW) 104 as known in the art. The NVW 104 typically has at least two panes of glass 106 and 108. The panes of glass may be held in window 104 with seals located on both sides of the door, such as seal 110. Condensation forms on the inside of window 104 when one pane 106 is subjected to cold temperatures and the other pane 108 to warmer temperatures.

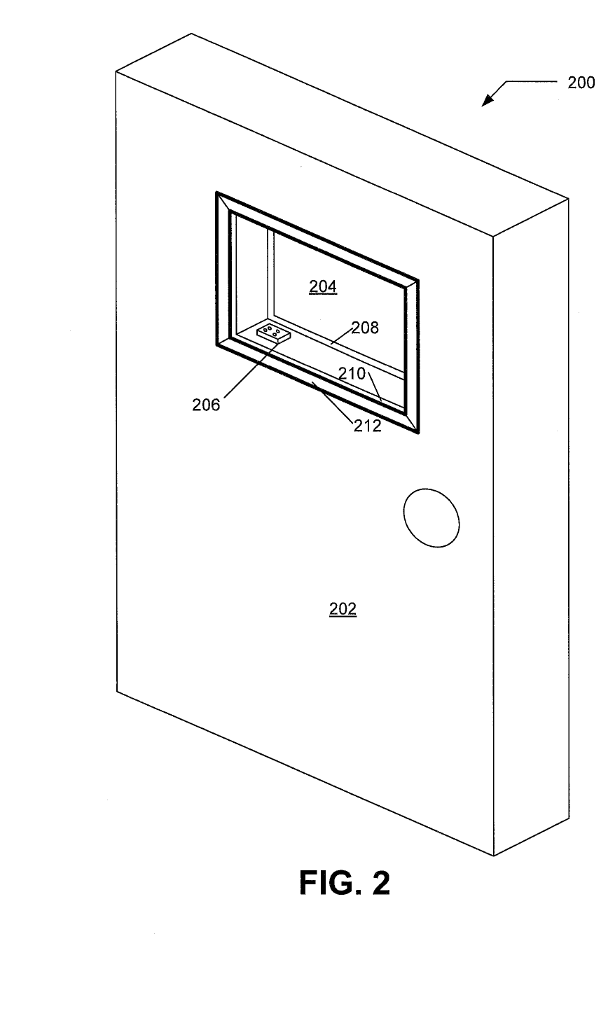

In FIG. 2, an illustration 200 freezer door 202 with a window 204 having a predetermined place 206 for silica located within the window 204 in accordance with an example implementation of the invention. The window may have at least two panes 208 and 210. The panes 208 and 210 may be held in place with seals on each side of the door 212. In other implementations, a single seal that extends to both sides of the door may be employed. In yet other implementations, a frame may be used with or in place of the seal.

A predetermined place 206 for silica may be affixed or formed between the panes 208 and 210. The silica (silica desiccant) absorbs moisture that may be present between the panes 208 and 210 of the window. The silica in the predetermined place 206 may be loose silica or be packaged into packets. It would be preferable to use packets to increase the ease of changing the silica when needed.

The predetermined place 206 may be a container that is molded or formed in the window 204 with a lid or a box like structure with a lid that is secured in the window 204 between panes 208 and 210. The lid may have one or more perforations that enable moisture (such as water vapor) to come in contact with the silica. In other implementations a bag structure secured in the window 204 between the panes 208 and 210 may be employed. The location of the predetermined place 206 may be anywhere within the window 204 between the panes 208 and 210, including the bottom, side, or top. Further, in other implementations, more than one predetermined place may be present within the window 204. The silica desiccant is an example of a type of material that absorbs moisture. Other materials with similar moisture absorbing properties may be used in place of silica or in addition to silica.

The panes 208 and 210 may be made of glass, polycarbon, or other transparent material. It is noted that polycarbon panes are stronger than glass but are gas permeable and enables water vapor to pass through the panes. The panes 208, 210 may be held in place within a window frame as depicted in FIG. 2, or in other implementations, the door 202 itself may act as a frame or support for the panes 208 and 210. The window and/or panes may be held in place with one or more seals 212 or gaskets. The seals may be made out of rubber or other suitable material that is semi-ridged (able to withstand the opening and shutting of the door).

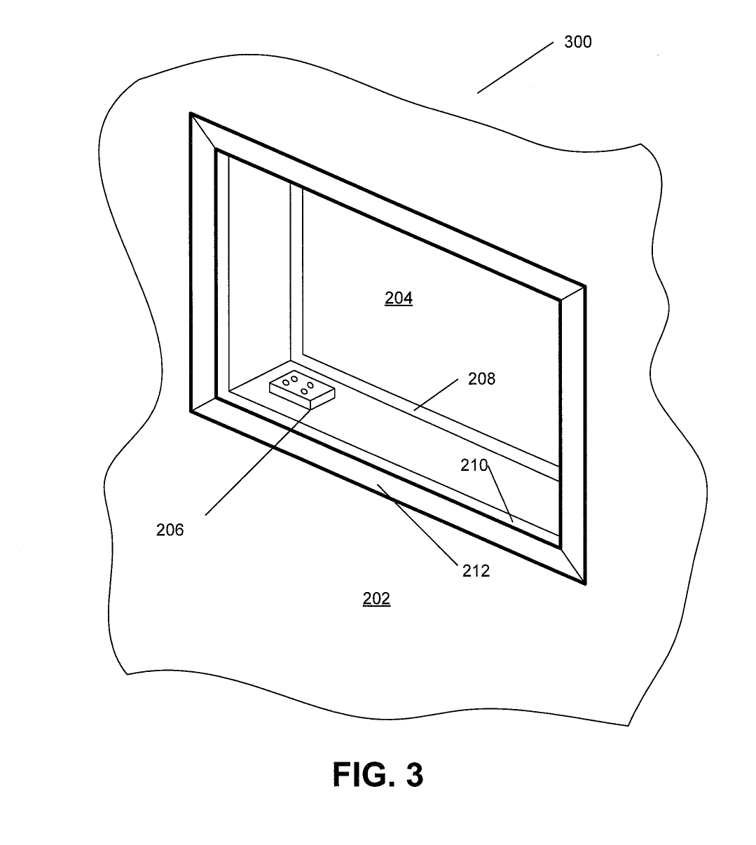

Turning to FIG. 3, an illustration 300 of a magnified view of the window 204 in door 202 depicted in FIG. 2 in accordance with an example implementation of the invention is shown. The lid 302 is viable on the predetermined place 206. The lid has a number of holes that enable water vapor to enter the predetermined place 206 which holds silica. When the silica needs to be replaced, the window may be removed or a pane may be removed to access the predetermined place 206. The lid 302 may be removed in order to access the silica and replace it when needed.

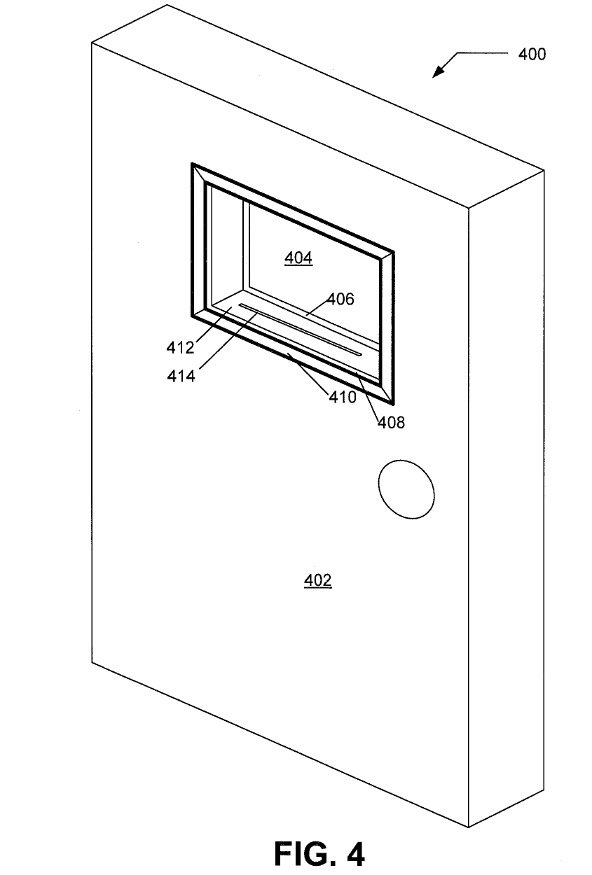

In FIG. 4, an illustration 400 of a door 402 having a seal 410 with a predetermined place 412 for silica within the window 404 in accordance with an example implementation of the invention is depicted. Rather than a traditional container, the seal 412 is formed to have a cavity 414 for holding packaged silica. The cavity 414 is formed between at least two panes 406 and 408 of the window 404.

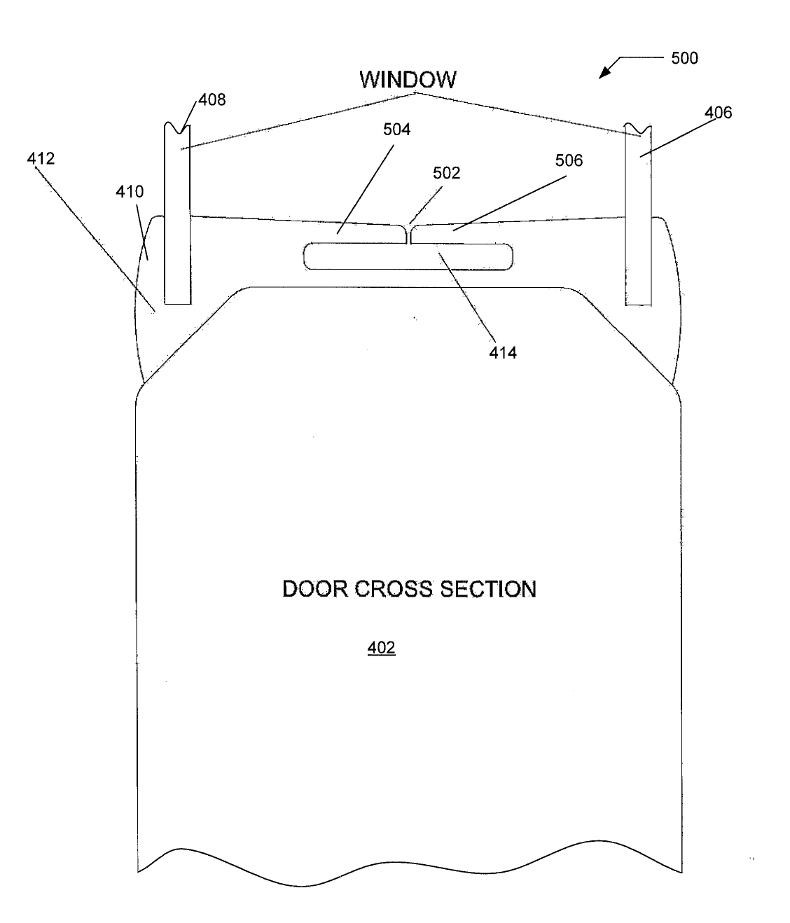

Turning to FIG. 5, an illustration of a magnified view 500 of seal 412 with a cavity 414 for silica within the window 404 of FIG. 4 in accordance with an example implementation of the invention is depicted. The seal 412 has a cavity 414 with a gap 502 that allows water vapor to enter the cavity 414. The cavity 414 is large enough to house one or more packets of silica (silica desiccant). Two lips 504 and 506 are formed on both side of the gap 502 and slope downward to the gap 502. If any condensed water forms between the panes 406 and 408 it would run down onto the seal 412 and be directed into the cavity 414 by the lips 504 and/or 506.

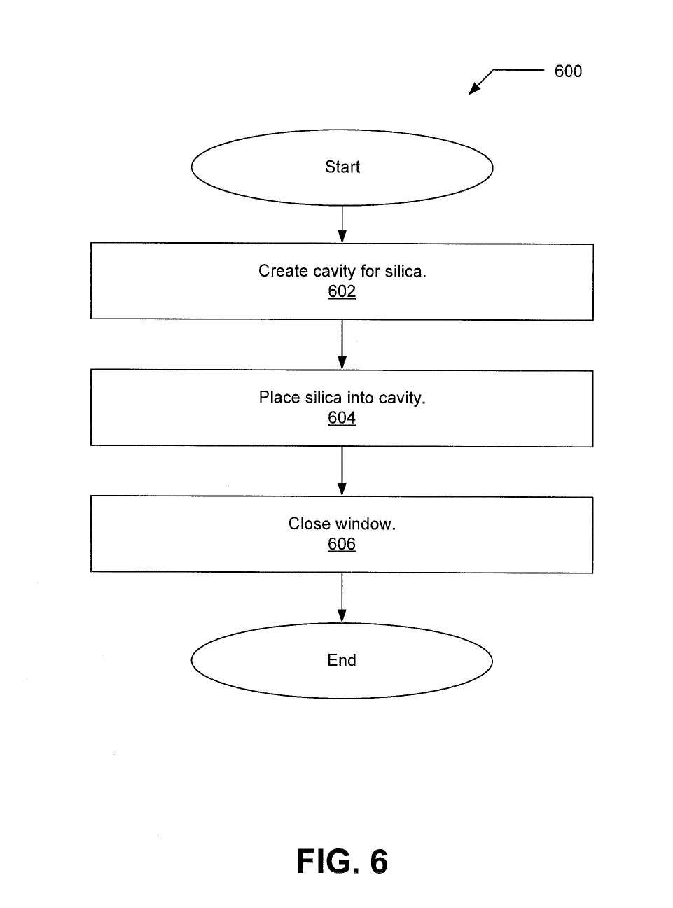

In FIG. 6, a flow diagram 600 of an approach for placing silica in the air space defined by the panes 408 and 406 of a window 402 is depicted in accordance with an example implementation of the invention. A cavity 414 is created that is vented or has access to the space between panes 406 and 408 in a window 404 in step 602. The cavity may be in the space between the panes or beside the space with air and water vapor able to flow between the cavity and the space between the panes. In step 604 silica such as silica desiccant, is placed in the cavity. The silica may be preferably packaged or free flowing. The window 404 may then be fully assembled and secured (if not already secured) in the door 402 in step 606. In order to replace the silica, the approach is reversed and the silica is removed.

The foregoing description of an implementation has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A non-vacuum window, comprising:
at least one seal;
a container; and
at least two window panes that are engaged the at least one seal and define an area between the at least two window panes and moisture is able to access the container from the area between the at least two window panes, where the container hold a material that absorbs moisture.

2. The non-vacuum window of claim 1, where the container has openings that enable the moisture to access the container.

3. The non-vacuum window of claim 2, where the container has a lid.

4. The non-vacuum window of claim 1, where the material that absorbs moisture is sealed in a packet.

5. The non-vacuum window of claim 1, where the material that absorbs moisture is desiccant.

6. The non-vacuum window of claim 1, where the at least one seal is a rubber seal.

7. The non-vacuum window of claim 1, where the area between the at least two window panes is formed within a door.

8. The non-vacuum window of claim 7, where the door is an insulated door.

9. The non-vacuum window of claim 12, where each of the two window panes is a polycarbon window pane.

10. A method for removing moisture, comprising:
forming an enclosed space between at least two panes of glass;
placing moisture absorbing material in the space enclosed space; and
absorbing water vapor from the enclosed space with the moisture absorbing material.

11. The method for removing moisture of claim 10, where placing moisture absorbing material, further includes enclosing the moisture absorbing material in a container having openings to allow the water vapor to enter.

12. The method for removing moisture of claim 10, where the moisture absorbing material is desiccant.

13. A non-vacuum window, comprising:
a seal;
at least two window panes that are engaged the seal and define an area between the at least two window panes; and
a material that absorbs moisture located in a cavity formed by the seal where moisture is able to access the cavity from the area between the at least two window panes.

14. The non-vacuum window of claim 13, where the seal is a rubber seal.

15. The non-vacuum window of claim 13, where the material is desiccant.

16. The non-vacuum window of claim 13, where the area is located in an insulated door.

17. The non-vacuum window of claim 13, where each of the two window panes is a polycarbon window pane.
